(19) United States
(12) Patent Application Publication
(10) Pub. No.: US 2006/0166852 A1
(43) Pub. Date: Jul. 27, 2006

(54) Anionic surfactant powder granules

(75) Inventors: Tatsuki Matsumoto, Wakayama (JP); Hidetoshi Nomoto, Wakayama (JP); Kazuhito Miyoshi, Wakayama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KAO CORPORATION, Chuo-ku (JP)

(21) Appl. No.: 11/319,134

(22) Filed: Dec. 28, 2005

(30) Foreign Application Priority Data
Jan. 13, 2005 (JP) 2005-006269
Jun. 27, 2005 (JP) 2005-186067

(51) Int. Cl. C11D 17/00

(52) U.S. Cl. 510/424

(57) ABSTRACT

The invention relates to anionic surfactant powder granules having an average particle diameter of 0.1 mm or more to less than 0.5 mm, a loose bulk density of 400 to 1000 kg/m³ and a compaction degree of 3 to 25%, containing an anionic surfactant in an amount of 80 to 100 wt % based on the total amount of the powder granules.

### FIELD OF THE INVENTION

The present invention relates to anionic surfactant powder granules. The present invention relates in particular to anionic surfactant powder granules which can be used preferably in, for example, a clothing detergent, a kitchen detergent, a toothpaste foaming agent, shampoo powder, an emulsion polymerization emulsifier, a medical emulsifier, a cosmetic emulsifier, a cement foaming agent etc.

### BACKGROUND OF THE INVENTION

The anionic surfactant is mixed with another surfactant or a builder and used not only in a clothing detergent, a kitchen detergent and a toothpaste foaming agent, but also in a medical emulsifier, a cosmetic emulsifier and other detergents.

As anionic surfactant powder granules, a dried product of an aqueous anionic surfactant solution, aqueous slurry or paste (hereinafter referred to merely as aqueous anionic surfactant solution or the like) or a product of the dried product further processed by milling and granulation in the form of powder, needles, noodles, flakes etc. has been known. Conventionally, anionic surfactant powder granules have been produced by drying an aqueous anionic surfactant solution or the like as the starting material by removing water, or by further subjecting it after drying to secondary processing such as milling or granulation.

The conventional method of producing a granulated anionic surfactant includes spray-drying methods such as a method of spray-drying low-concentration slurry having a water content of 60 to 70 wt % (JP-A 55-69698, JP-A 53-39037) and a method of spray-drying high-density slurry of an alkyl sulfate having a solids content of 60 to 80 wt % (JP-A 54-106428). JP-A 2-222498 discloses a method of drying a high-density detergent paste starting material having a water content of 20 to 35 wt % by using a vacuum film drying machine.

JP-A 5-331496 discloses a method of giving a flaky dried material, which includes feeding a paste starting material for high-density detergent into a cylindrical casing under vacuum, to form a film of the paste starting material for high-density detergent on an inner wall by the tip of a rotatable plate-shaped blade, simultaneously rapidly drying the film and scratching it away with the plate-shaped blade.

U.S. Pat. No. 5,646,107 and JP-A (W) 2002-508783 disclose a method of drying and simultaneously granulating a paste by a flash process or a flash drying machine. WO-A 95/01959 discloses a process for producing a granulated product of alkyl sulfuric acid.

### SUMMARY OF THE INVENTION

The present invention relates to anionic surfactant powder granules having an average particle diameter of 0.1 mm or more to less than 0.5 mm, a loose bulk density of 400 to 1000 kg/m³ and a compaction degree of 3 to 25%, containing an anionic surfactant in an amount of 80 to 100 wt % based on the total amount of the powder granules.

The present invention also relates to a process for producing the anionic surfactant powder granules described above, which includes feeding an aqueous solution of an anionic surfactant into a granulator having an agitating element and a crushing element under reduced pressure, while drying and simultaneously granulating it.

In other words, the present invention is a process for producing the anionic surfactant powder granules described above, which includes the step of drying and simultaneously granulating an aqueous solution of an anionic surfactant, while feeding the aqueous solution into a granulator having an agitating element and a crushing element at a reduced pressure.

### DETAILED DESCRIPTION OF THE INVENTION

It is important performance that the anionic surfactant powder granules when used are rapidly dissolved, or the anionic surfactant powder granules when used as a mixture with other powdery starting materials are uniformly dispersed. For this reason, the average particle diameter of the anionic surfactant powder granules is preferably smaller. As the anionic surfactant powder granules having a relatively small particle diameter, powder granules obtained by the spray-drying described in the patent publications supra or those having a reduced particle size by further subjecting the powder granules after drying to milling are known. However, the anionic surfactant powder granules obtained by spray-drying have low bulk density, thus requiring an enormous volume for transport and storage and making required costs enormous. The anionic surfactant powder granules subjected after drying to milling have relatively high bulk density, but are poor in fluidity and undergo caking during storage, to cause a problem of significant deterioration in handle ability.

The present invention relates to anionic surfactant powder granules excellent in solubility and dispersibility, superior in fluidity and excellent in caking resistance.

The anionic surfactant powder granules of the present invention are excellent in fluidity and can be dissolved at a high rate of dissolution and dispersed uniformly without caking. Further, the anionic surfactant powder granules are excellent in transport efficiency and charging efficiency.

[Anionic Surfactant]

The anionic surfactant used in the present invention is not particularly limited, and examples thereof include alkyl or alkenyl sulfates, polyoxyalkylene alkyl or alkenyl ether sulfates, α-olefin sulfonates, alkyl benzene sulfonates, α-sulfofatty acid salts or ester salts, and alkyl or alkenyl ether carboxylates. Among these, alkyl or alkenyl sulfates, polyoxyalkylene alkyl or alkenyl ether sulfates are preferable, and alkyl or alkenyl sulfates are particularly preferable. The salts or sulfates include an alkali metal salt, alkaline earth metal salt, ammonium salt, alkanol amine salt, etc. Among these salts, an alkali metal salt is preferable, and a sodium or potassium salt and a mixture of such salts are also preferable.

Particularly preferable among these anionic surfactants is at least one member selected from the group consisting of alkyl or alkenyl sulfates represented by the following formula (I) and polyoxyalkylene alkyl or alkenyl ether sulfates represented by the following formula (II):
(R¹O—SO₃)ₚM¹ (I)
wherein R¹ represents a C8 to C24 linear or branched alkyl or alkenyl group, M¹ represents a cation, and p is the valence of M¹ and represents 1 or 2;
(R²O—(AO)ₘSO₃)_{q}M² (II)
wherein R² represents a C8 to C24 linear or branched alkyl or alkenyl group; A represents a C2 to C4 alkylene group, and A's whose number is m may be the same or different; m is the average number of moles of alkylene oxide added, and represents a number of 0.05 to 20; M² represents a cation; and q is the valence of M², and represents 1 or 2.

In the general formulae (I) and (II), the number of carbon atoms in R¹ or R² is preferably 8 to 20, more preferably 10 to 18, from the viewpoint of the caking resistance and solubility of the powder granules. A is preferably a C2 to C4, particularly C2, alkylene group. From the viewpoint of attaining excellent powder characteristics and improving the caking resistance of the powder granules, m is preferably 0.05 to 2, more preferably 0.1 to 1, still more preferably 0.2 to 0.8. Each of M¹ and M² is preferably an alkali metal atom such as Na, K etc., an alkaline earth metal atom such as Ca, Mg etc., or an alkanol-substituted or inorganic atom-substituted ammonium group, more preferably an alkali metal atom, still more preferably Na.

The alkyl or alkenyl sulfate represented by the formula (I) above is obtained for example by sulfating a C8 to C24, preferably C8 to C20, alcohol (referred to hereinafter as higher alcohol) and then neutralizing the product. The polyoxyalkylene alkyl or alkenyl ether sulfate represented by the formula (II) is obtained for example by sulfating a higher alcohol/alkylene oxide adduct having alkylene oxide added in an average mole number of 0.05 to 20, preferably 0.05 to 2, to a higher alcohol, and then neutralizing the product.

Sulfation and neutralization can be carried out in a known method. A sulfation agent used in the sulfation is preferably sulfur trioxide or chlorosulfonic acid. When a sulfur trioxide gas is used, the gas is usually diluted with an inert gas, preferably with dry air or nitrogen, and used as a gas mixture containing 1 to 8 vol %, preferably 1.5 to 5 vol %, sulfur trioxide. The neutralization agent includes sodium hydroxide, potassium hydroxide, sodium carbonate etc.

[Anionic Surfactant Powder Granules]

From the viewpoint of exhibiting the functions of an anionic surfactant itself, the anionic surfactant powder granules of the present invention contain the anionic surfactant in an amount of 80 wt % or more, preferably 90 wt % or more, more preferably 95 wt % or more, based on the total amount of the powder granules. The upper limit of the content of the anionic surfactant is 100 wt % or less, preferably 98 wt % or less, from the viewpoint of handling.

The anionic surfactant powder granules of the present invention may contain a water-soluble inorganic salt other than the anionic surfactant. The water-soluble inorganic salt includes, for example, sodium chloride, Glauber's salt, sodium carbonate etc. The content of the water-soluble inorganic salt in the anionic surfactant powder granules of the present invention is not particularly limited, but from the viewpoint of maintaining a high solids content of the anionic surfactant, the content of the water-soluble inorganic salt is not more than 10 parts by weight, preferably not more than 2 parts by weight, based on 100 parts by weight of the anionic surfactant.

The anionic surfactant powder granules of the present invention can contain a surfactant other than the anionic surfactant. The surfactant other than the anionic surfactant includes a cationic surfactant and nonionic surfactant.

If necessary, the anionic surfactant powder granules of the present invention can contain other additives. The other additives include, for example, alkalis such as silicate, carbonate etc., divalent metal ion scavengers such as citrate, zeolite etc., re-contamination inhibitors such as polyvinyl pyrrolidone, carboxymethyl cellulose etc., caking inhibitors, antioxidants etc. These other additives can be used in such a range that the object of the present invention is not hindered.

The average particle diameter of the anionic surfactant powder granules of the present invention is 0.1 mm or more to less than 0.5 mm, and from the viewpoint of productivity and reduction in heat loading, the average particle diameter is preferably 0.15 mm or more, more preferably 0.2 mm or more. From the viewpoint of high-speed solubility and uniform dispersibility, the average particle diameter is preferably 0.4 mm or less, more preferably 0.35 mm or less. The average particle diameter of the powder granules in the present invention is calculated from the weight fraction of the powder granules having passed through a standard sieve according to JIS Z 8801 after being vibrated for 5 minutes.

The loose bulk density of the anionic surfactant powder granules of the present invention is 400 to 1000 kg/m³, and from the viewpoint of charging efficiency, the loose bulk density is preferably at least 500 kg/m³, more preferably at least 600 kg/m³. The upper limit is desirably near to true density, and is preferably not more than 900 kg/m³ from the viewpoint of actual manufacturing. In the present invention, “loose bulk density” means “loose apparent specific density” measured by Powder Tester PT-E (manufactured by Hosokawa Micron Co., Ltd.).

The degree of compaction of the anionic surfactant powder granules of the present invention is 25% or less, preferably 15% or less, more preferably 10% or less, from the viewpoint of caking resistance and handling. From the viewpoint of productivity and manufacture, the degree of compaction is preferably 3% or more.

The degree Of compaction (C) of the anionic surfactant powder granules in the present invention is expressed by the formula below wherein A is loose bulk density, and P is solid bulk density. The loose bulk density A is loose apparent specific density measured by Powder Tester PT-E (manufactured by Hosokawa Micron Co., Ltd.), and the solid bulk density P is solid apparent specific gravity measured by Powder Tester PT-E (manufactured by Hosokawa Micron Co., Ltd.).
C[%]=100×(p−A)/P

The means of reducing the degree of compaction can be achieved by any one of methods for improvement of the shape of particles (for example, formation of particles in a spherical form), the surface state of particles (state of smoothness), the strength of particles (difficulty in collapsing and crushing), and the uniformity of size and specific gravity, or by a combination of such methods.

In the present invention, the granules having a relatively small particle diameter, that is, an average particle diameter of 0.1 mm or more to less than 0.5 mm, can be endowed with excellent caking (cohesion) resistance by reducing the degree of compaction to 25% or less, and as a result, there is technical importance in significant improvement of properties such as solubility at use, uniform dispersibility and fluidity.

The water content of the anionic surfactant powder granules of the present invention is preferably 0.3 to 2.5 wt %, more preferably 2.0 wt % or less from the viewpoint of caking resistance, or more preferably 0.5 wt % or more from the viewpoint of reducing the amount of dust. The water content of the powder granules is determined by the heating loss method, the distillation method, the Karl Fischer's method (JIS K0068) etc., and the water content in this specification is a value determined by the Karl Fischer's method (JIS K 0068).

The caking resistance of the anionic surfactant powder granules of the present invention, in terms of the degree of passage through a sieve in a caking test, is preferably 85% or more, more preferably 90% or more, still more preferably 95% or more. In the method of measuring caking resistance in the present invention, 100 mL anionic surfactant powder granules are sealed into a vinyl bag equipped with a 0.04×70×100 mm zipper, then uniformly loaded thereon with 1000 kg/m² load, stored at a storage temperature of 50° C. for 7 days, then placed gently on a 2000-μm sieve, and low-tapped 10 times to allow the powder granules to pass through the 2000-μm sieve, and in terms of the degree of passage thereof, the caking resistance is evaluated.

The anionic surfactant powder granules of the present invention are particularly preferably those satisfying all of the following conditions (A) to (D):

(A) Average particle diameter: 0.1 mm or more to less than 0.5 mm.

(B) Loose bulk density: 400 to 1000 kg/m³.

(C) Degree of compaction: 3 to 25%.

(D) Content of anionic surfactant: 80 to 100 wt %.

[Process for Producing the Anionic Surfactant Powder Granules]

The process for producing the anionic surfactant powder granules of the present invention is not particularly limited, but is preferably a process that involves introducing an aqueous anionic surfactant solution into a granulator having an agitating blade and a crushing element under reduced pressure while effecting drying and simultaneous granulation thereof. Preferably, the powder starting material is previously introduced into the granulator prior to introduction of the aqueous anionic surfactant solution.

The water content of the aqueous anionic surfactant solution used in this process is preferably 20 to 40 wt % from the viewpoint of fluidity and reducing energy load at the time of drying. The viscosity of the aqueous anionic surfactant solution is preferably 50 Pa·s or less, more preferably 30 Pas or less, still more preferably 15 Pas or less. From the viewpoint of manufacturing, the viscosity is preferably 3 Pas or more. The viscosity of the aqueous anionic surfactant solution is measured by a Brookfield viscometer. The temperature of the aqueous anionic surfactant solution is preferably 30° C. or more, more preferably 40° C. or more, still more preferably 50° C. or more, from the viewpoint of handing. From the viewpoint of heat stability, the temperature of the aqueous anionic surfactant solution is preferably lower than 100° C., more preferably lower than 80° C., still more preferably lower than 70° C. The viscosity of the aqueous anionic surfactant solution can be regulated by the amount of water and/or temperature of the aqueous solution.

From the viewpoint of purity or caking resistance of the powder granules, the content of unreacted material in the aqueous anionic surfactant solution is preferably 5 wt % or less, more preferably 2 wt % or less, relative to the anionic surfactant. Since the product of smaller particle diameter can be easily obtained as the unreacted material is decreased, the content of the unreacted material is further preferably 1.5 wt % or less, further more preferably 1.3 wt % or less, even more preferably 1.0 wt % or less. The unreacted material includes an alcohol not sulfated at the time of production of the anionic surfactant, an alkoxylate, and a very small amount of hydrocarbons, wax etc. produced as byproducts in the reaction.

The aqueous anionic surfactant solution may contain water-soluble inorganic salts. Typical examples of such water-soluble inorganic salts include, for example, sodium chloride, Glauber's salt, sodium carbonate etc. These water-insoluble inorganic salts may be used as such or may be those produced as byproducts in the reaction. For example, NaCl (sodium chloride) is produced as a byproduct when NaClO (sodium hypochlorite) is added to the aqueous anionic surfactant solution for the purpose of improving hue. In this way, sodium hypochlorite can be added to form sodium chloride as an inorganic salt.

Preferably, the powder starting material used during production of the anionic surfactant powder granules of the present invention contains at least one member selected from the group consisting of a surfactant, a water-soluble inorganic salt and a water-insoluble inorganic salt, and a part of the anionic surfactant powder granules of the present invention, or a crushed product of the anionic surfactant powder granules, is more preferably used as the powder starting material. The surfactant, water-soluble inorganic salt and water-insoluble inorganic salt in the powder starting material include the materials illustrated as those to be contained in the anionic surfactant powder granules. From the viewpoint of handling and ease in regulating the drying speed and the particle size of the final granulated product, the particle diameter of the powder starting material is preferably 0.3 mm or less, more preferably 0.2 mm or less, still more preferably 0.1 mm or less.

The grinder used in obtaining the powder starting material includes, for example, an atomizer (manufactured by Fuji Paudal Co., Ltd.), Fitz Mill (manufactured by Dulton Co., Ltd.), a pulverizer (manufactured by Dulton Co., Ltd.), a power mill (manufactured by Powrex), Comill (manufactured by Quadro) etc.

When the temperature of the powder granules during drying and simultaneous granulation in the process described above is too low, high vacuum may be necessary thus requiring large energy, while when the temperature is too high, productivity is lowered and simultaneously a high-temperature heating source is necessary and the risk of pyrolysis is increased, so the temperature of the powder granules is preferably 35° C. or more, more preferably 40° C. or more, still more preferably 45° C. or more. At the same time, the temperature of the powder granules is preferably 85° C. or less, more preferably 75° C. or less, still more preferably 70° C. or less. Drying and simultaneous granulation are carried out while the change in temperature of the powder granules is regulated preferably within ±5° C., more preferably within ±2° C., still more preferably within ±1° C.

The method of regulating the change in temperature includes methods involving suitable regulation of (1) the amount of the aqueous anionic surfactant solution added and the rate of addition thereof, (2) the pressure in the granulator, (3) the jacket temperature in the granulator, (4) the introduction of air, an inert gas and/or water vapor into the granulator, or (5) the Froude number of the agitating element in the granulator. Hereinafter, these methods are described in detail respectively.

(1) The Amount of the Aqueous Anionic Surfactant Solution Added and the Rate of Addition Thereof.

The amount of the aqueous anionic surfactant solution added and the rate of addition thereof are regulated preferably such that the temperature of the powder granules comes to be within the range described above. The ratio of the aqueous anionic surfactant solution added, in terms of the aqueous anionic surfactant solution/powder staring material ratio by weight, is preferably 1/10 to 10/1, more preferably 4/4 to 7/1. With respect to the speed of addition, the time having elapsed until the operating temperature is reached after initiation of dropping of the aqueous anionic surfactant solution is long, the granulated product is hardly obtained, while when the speed of dropping is too high, the product may be roughened to make stable operation difficult. Accordingly, the ratio of the time having elapsed until the operating temperature is reached to the time in which the aqueous anionic surfactant solution is dropped is preferably 1/50 to 1/3.

(2) The Pressure in the Granulator

From the viewpoint of suppressing decomposition of the aqueous solution and the granulated product by reducing the operating temperature, the pressure in the granulator is preferably 40 kPa or less, more preferably 20 kPa or less, still more preferably 10.0 kPa or less. From the viewpoint of the burden on a vacuum pump or the air-tightness of the granulator, the pressure in the granulator is preferably 0.67 kPa or more, more preferably 1.5 kPa or more, still more preferably 4.0 kPa or more.

(3) The Jacket Temperature in the Granulator

The heating source in the granulator includes a hot water jacket, electric tracing etc., among which the hot water jacket is preferable, and the jacket temperature is preferably 100° C. or less, more preferably 90° C. or less, from the viewpoint of application to a heat-sensitive starting material.

(4) The Introduction of Air, an Inert Gas and/or Water Vapor into the Granulator

In the present invention, air, an inert gas and/or water vapor may be introduced into the aqueous anionic surfactant solution in the granulator in order to effect drying more effectively. The rate of air, an inert gas and/or water vapor introduced is preferably 2 to 30 L/min., more preferably 3 to 10 L/min.

(5) The Froude Number of the Agitating Element in the Granulator

From the viewpoint of promoting compaction and forming an adhering layer sufficiently to decrease the particle-size distribution in the present invention, the Froude number defined by the equation below is preferably 1 to 5, more preferably 1.5 to 4.
Fr=V/[(R×g)^{0.5}]
wherein Fr is Froude number, V is the peripheral speed at the tip of an agitating element [m/s], R is the radius of gyration of an agitating element [m], and g is the acceleration of gravity [m/sec.²]

The granulator used in the present invention is preferably the one equipped with an agitating element and a crushing element, wherein upon rotation of the agitating element, clearance is formed between the agitating element and the wall surface. The average clearance is preferably 1 to 30 mm, more preferably 3 to 10 mm. When the average clearance is 1 mm or more, the compaction density of an adhering layer is suitable. When the average clearance is 30 mm or less, the productivity is good with good compaction efficiency without broadening the particle-size distribution.

The granulator having preferably used in the present invention includes, for example, granulators in a batch system such as Henschel mixer [manufactured by Mitsui Miike Machinery Co., Ltd.], a high-speed mixer [manufactured by Fukae Powtec Co.], a vertical granulator [manufactured by Powrex], Redige mixer [manufactured by Matsuzaka Giken Co., Ltd.], Proshear mixer [Taiheiyo Kikou Co., Ltd.] etc., particularly preferably Redige mixer [manufactured by Matsuzaka Giken Co., Ltd.], a high-speed mixer [manufactured by Fukae Powtec Co.] and Proshear mixer [Taiheiyo Kikou Co., Ltd.]. The continuous granulator includes continuous Redige mixer (middle-speed mixer with a relatively long retention time) and high-seed mixers (with a relatively short retention time) such as CB recycler (manufactured by Loedige), Turbulizer (manufactured by Hosokawa Micron Co., Ltd.), Schugi mixer (manufactured by Powrex) and a flow-jet mixer (manufactured by Funken Inc.).

The granulator used in the present invention is preferably the one having a jacket for regulating the inside temperature (operating temperature) or a nozzle for gas blowing. More preferable examples of such granulators include granulators described in JP-A 10-296064, JP-A 10-296065 and JP-B 3165700.

In the present invention, drying and simultaneous granulation are conducted preferably while a gas is blown in. By doing so, water is evaporated, and the resulting powder granules are cooled with the gas so that the powder granules are prevented from forming larger lumps. Such gas includes a nitrogen gas, air and/or water vapor.

Fine powder may remain after addition of the aqueous anionic surfactant solution is finished, so it is preferable from the viewpoint of incorporation of the fine powder (re-adhesion of the fine powder to the powder granules) that the process of the present invention includes a step of rotating the agitating element only without substantially rotating the crushing element.

For further improving e.g. caking resistance, the anionic surfactant powder granules of the present invention can be blended if necessary with crystalline aluminosilicates such as A-type, P-type, X-type and Y-type zeolite, inorganic powder such as Glauber's salt, or alkyl sulfate powder in order to coat the particle surfaces therewith.

The anionic surfactant powder granules of the present invention may be colored with a known colorant such as a pigment or a dye in order to improve the outward appearance of the granulated product itself. The coloring method is not particularly limited, and it is possible to employ, for example, a coloring method which includes spraying the surfaces of anionic surfactant powder granules with an aqueous solution containing a dye or a pigment as described in JP-A 2-258872 or a method of coloring anionic surfactant powder granules by incorporating a suitable amount of a dye or a pigment into an aqueous anionic surfactant solution as described in JP-A 11-158493. The colorant used is not particularly limited, but is preferably a highly soluble or dispersible colorant, and preferable examples include red oxide, ultramarine, Rionol Green, Red No. 226, Red No. 405, Blue No. 1 etc.

### EXAMPLES

Hereinafter, the present invention is described in more detail by reference to the Examples. The Examples are set forth for merely illustrating the present invention, and not intended to limit the present invention.

In the Examples, % refers to % by weight unless otherwise specified.

### Synthesis Example 1

A higher alcohol (molecular weight 199) having C12 to C16 alkyl groups having a distribution of C₁₂/C₁₄/C₁₆=67%/28%/5%, together with 2.0 vol-% sulfur trioxide gas, was continuously introduced into, and reacted in, a film flow-type reactor at 60° C. having an inner diameter of 16 mmφ and a length of 5 m. The flow rate was regulated such that the reaction molar ratio of the sulfur trioxide gas to the higher alcohol became 1.01. The resulting sulfated product was neutralized with 32.2% aqueous sodium hydroxide solution, then 75% phosphoric acid (buffer agent) was added, and the mixture was adjusted finely to pH 10 and further regulated such that the water content became 24%, whereby an aqueous sodium alkyl sulfate solution (referred to hereinafter as aqueous sodium alkyl sulfate solution 1) was obtained.

### Synthesis Example 2

An aqueous sodium alkyl sulfate solution with a water content of 24% (referred to hereinafter as aqueous sodium alkyl sulfate solution 2) was obtained in the same manner as in Synthesis Example 1 except that the reaction molar ratio of the sulfur trioxide gas to the higher alcohol was 1.015, and the pH was adjusted to 8.

### Synthesis Example 3

A higher alcohol (molecular weight 193) having C12 to C14 alkyl groups having a distribution of C₁₂/C₁₄=73%/27%, together with 2.0 vol-% sulfur trioxide gas, was continuously introduced into, and reacted in, a film flow-type reactor at 60° C. having an inner diameter of 16 mmφ and a length of 5 m. The flow rate was regulated such that the reaction molar ratio of the sulfur trioxide gas to the higher alcohol became 1.01. The resulting sulfated product was neutralized with 33.5% aqueous sodium hydroxide solution, then 85% phosphoric acid (buffer agent) and 20% aqueous solution of Glauber's salt were added, and the mixture was adjusted finely to pH 9.4 with 33.5% aqueous sodium hydroxide solution and further regulated such that the water content became 24%, whereby an aqueous sodium alkyl sulfate solution (referred to hereinafter as aqueous sodium alkyl sulfate solution 3) was obtained.

### Example 1

4.3 kg sodium alkyl sulfate powder [EMAL 10P-HD, average particle diameter 0.08 mm, manufactured by Kao Corporation] was introduced into a 65-L vacuum drying machine [FMD-65JE type, manufactured by Fukae Powtec Co.], and feeding of the aqueous sodium alkyl sulfate solution 1 having a water content of 24% heated at a temperature of a temperature of 50° C. was initiated at an addition speed of 14.4 kg/hr, and while the flow rate of the solution 1 fed was regulated such that the temperature of the resulting dried product became 60±2° C., the powder starting material was dried and simultaneously granulated under drying and granulating conditions where the jacket temperature was 80° C., the pressure in the machine was 5.3 kPa, the number of revolutions of an agitating element was 200 rpm, and the number of revolutions of a crushing element was 0 rpm. Thereafter, the drying and granulation were finished when the total amount of the aqueous solution fed became 20 kg, whereby powder granules of the sodium alkyl sulfate [average molecular weight 301] were obtained.

### Example 2

130 kg sodium alkyl sulfate powder [EMAL 10P-HD, average particle diameter 0.08 mm, manufactured by Kao Corporation] was introduced into a 2500-L vacuum drying machine [FMD-1200JE type, manufactured by Fukae Powtec Co.], and while the aqueous sodium alkyl sulfate solution 2 having a water content of 24% heated at a temperature of 55° C. was supplied such that the temperature of the resulting dried product became 48±2° C., the powder starting material was dried and simultaneously granulated under drying and granulating conditions where the jacket temperature was 75° C., the pressure in the machine was 4.0 kPa, the number of revolutions of an agitating element was 70 rpm, and the number of revolutions of a crushing element was 2000 rpm. Thereafter, the drying and granulation were finished when the total amount of the aqueous solution fed became 650 kg, whereby powder granules of the sodium alkyl sulfate were obtained.

### Example 3

130 kg powdery starting material [average particle diameter 0.03 mm] obtained by crushing the sodium alkyl sulfate powder granules obtained in Example 2 by an atomizer (FIIS-5 type, manufactured by Fuji Paudal Co., Ltd.) was introduced into a 2500-L vacuum drying machine [FMD-1200JE type, manufactured by Fukae Powtec Co.], and while the aqueous sodium alkyl sulfate solution 2 having a water content of 24% heated at a temperature of 55° C. was supplied such that the temperature of the resulting dried product became 42±2° C., the powder starting material was dried and simultaneously granulated under drying and granulating conditions where the jacket temperature was 65° C., the pressure in the machine was 4.0 kPa, the number of revolutions of an agitating element was 70 rpm, and the number of revolutions of a crushing element was 2000 rpm. Thereafter, the drying and granulation were finished when the total amount of the aqueous solution fed became 650 kg. Subsequently, the dried product was treated for 15 minutes under the conditions where the number of revolutions of the agitating element was 15 rpm, the number of revolutions of the crushing element was 0 rpm, the jacket temperature was 65° C., and the pressure in the machine was 4.0 kPa, whereby powder granules of the sodium alkyl sulfate were obtained. Then, the resulting powder granules were treated at an air passage rate of 0.5 m/sec. in a horizontal continuous vibrational fluidized bed [Q Unit Vibrational Cooling Machine, Q-456 type, manufactured by Tamagawa Kikai Co., Ltd.] and classified through a vibrational sieve having an opening of 0.84 mm [702-C type, manufactured by Dulton Co., Ltd.].

### Example 4

130 kg powdery starting material [average particle diameter 0.03 mm] obtained by crushing the sodium alkyl sulfate powder granules obtained in Example 2 by an atomizer (FIIS-5 type, manufactured by Fuji Paudal Co., Ltd.) was introduced into a 2500-L vacuum drying machine [FMD-1200JE type, manufactured by Fukae Powtec Co.], and while the aqueous sodium alkyl sulfate solution 2 having a water content of 24% heated at a temperature of 55° C. was supplied such that the temperature of the resulting dried product became 38±1° C., the powder starting material was dried and simultaneously granulated under drying and granulating conditions where the jacket temperature was 65° C., the pressure in the machine was 4.0 kPa, the number of revolutions of an agitating element was 70 rpm, and the number of revolutions of a crushing element was 2000 rpm. Thereafter, the drying and granulation were finished when the total amount of the aqueous solution fed became 650 kg. Subsequently, the dried product was treated for 15 minutes under the conditions where the number of revolutions of the agitating element was 15 rpm, the number of revolutions of the crushing element was 0 rpm, the jacket temperature was 65° C., and the pressure in the machine was 4.0 kPa, whereby powder granules of the sodium alkyl sulfate were obtained.

### Example 5

4.3 kg sodium alkyl sulfate powder [EMAL 10P-HD, average particle diameter 0.08 mm, manufactured by Kao Corporation] was introduced into a 65-L vacuum drying machine [FMD-65JE type, manufactured by Fukae Powtec Co.], and after feeding of the aqueous sodium alkyl sulfate solution 2 having a water content of 24% heated at a temperature of 50° C. was initiated at 17 kg/hr, the flow rate of the solution 2 was regulated such that the temperature of the resulting dried product became 60±2° C., while the powder starting material was dried and simultaneously granulated under drying and granulating conditions where the jacket temperature was 80° C., the pressure in the machine was 6.7 kPa, the number of revolutions of an agitating element was 200 rpm, and the number of revolutions of a crushing element was 0 rpm. Thereafter, the drying and granulation were finished when the total amount of the aqueous solution fed became 20 kg, whereby powder granules of the sodium alkyl sulfate [average molecular weight 301] were obtained.

### Example 6

160 kg powdery starting material [average particle diameter 0.03 mm] obtained by crushing the sodium alkyl sulfate powder granules obtained in Example 3 by an atomizer (FIIS-5 type, manufactured by Fuji Paudal Co., Ltd.) was introduced into a 2500-L vacuum drying machine [FMD-1200JE type, manufactured by Fukae Powtec Co.], and while the aqueous sodium alkyl sulfate solution 3 having a water content of 24% heated at a temperature of 55° C. was supplied such that the temperature of the resulting dried product became 42±2° C., the powder starting material was dried and simultaneously granulated under drying and granulating conditions where the jacket temperature was 65° C., the pressure in the machine was 4.0 kPa, the number of revolutions of an agitating element was 70 rpm, and the number of revolutions of a crushing element was 2000 rpm. Thereafter, the drying and granulation were finished when the total amount of the aqueous solution fed became 700 kg. Subsequently, the dried product was treated for 20 minutes under the conditions where the number of revolutions of the agitating element was 15 rpm, the number of revolutions of the crushing element was 0 rpm, the jacket temperature was 65° C., and the pressure in the machine was 4.0 kPa, whereby powder granules of the sodium alkyl sulfate were obtained.

### Comparative Example 1

The aqueous sodium alkyl sulfate solution 1 with a water content of 24% heated at a temperature of 60° C. was fed at 13.3 kg/hr through an upper inlet into a film drying machine (Sebcon manufactured by Hitachi, Ltd.) having a heat transfer area of 0.3 m² by a pump for high-viscosity paste (4NES60 type, manufactured by HEISHIN, Ltd.), and continuously dried under conditions where the number of revolutions of a blade was 900 rpm, the pressure in the drying machine was 9.2 kPa, and the drying temperature was 110° C. The resulting dried product was crushed with a grinder (atomizer, manufactured by Fuji Paudal Co., Ltd.) to give powder having an average particle diameter of 0.08 mm and a water content of 1.3%.

### Comparative Example 2

A dried product was obtained in the same manner as in Comparative Example 1, and then the resulting dried product was crushed with a grinder (atomizer, manufactured by Fuji Paudal Co., Ltd.) to give powder having an average particle diameter of 0.25 mm and a water content of 1.3%.

### Comparative Example 3

Using a spray-drying tower having a tower diameter of 3 m and a tower height of 17 m, an aqueous sodium alkyl sulfate solution with a water content of 70% (prepared by adding water to the aqueous sodium alkyl sulfate solution 1 having a water content of 24%) heated at a temperature of 60° C. was sprayed at a feed rate of 110 kg/hr through a spray nozzle positioned at a site 8 m below the tower, and spray-dried by blowing hot air as countercurrent at a temperature of 200° C. at 80 Nm³/min. The temperature of air discharged from the top of the tower was 97° C., and spray-dried particles having an average particle diameter of 0.14 mm and a water content of 1.0 wt % were obtained from the bottom of the tower.

The production conditions in Examples 1 to 6 and Comparative Examples 1 to 3, the compositions and physical properties of the resulting anionic surfactant powder granules are collectively shown in Table 1. The rate of dissolution was measured by the following method, and the other physical properties were determined by the methods described above.

<Rate of Dissolution>

995 g deionized water (30° C.) was agitated (900 rpm), and 5 g anionic surfactant powder granules were added all at once. The electric conductance was measured with time by an electric conductance meter [DS-8F manufactured by HORIBA], and the 99% value (time) when the electrical conductance was stabilized is expressed as the rate of dissolution.

TABLE 1

| | | Examples | | | | | | Comparative examples | | |
|---|---|---|---|---|---|---|---|---|---|---|
| | | 1 | 2 | 3 | 4 | 5 | 6 | 1 | 2 | 3 |
| Production | Temperature of dried product (° C.) | 60 ± 2 | 48 ± 2 | 42 ± 2 | 38 ± 1 | 60 ± 2 | 42 ± 2 | — | — | — |
| conditions | Jacket temperature (° C.) | 80 | 75 | 65 | 65 | 80 | 65 | — | — | — |
| | Pressure in granulator (kPa) | 5.3 | 4.0 | 4.0 | 4.0 | 6.7 | 4.0 | — | — | — |
| Powder | Anionic surfactant (%) | 97.5 | 98.2 | 98.3 | 97.8 | 98.0 | 93.3 | 96.2 | 96.2 | 97.1 |
| granule | Water cotent (%) | 1.9 | 0.9 | 1.1 | 1.7 | 1.0 | 1.7 | 1.3 | 1.3 | 1.0 |
| composition | Unreacted material (%) | 1.4 | 0.8 | 0.8 | 0.8 | 0.7 | 1.2 | 1.3 | 1.3 | 0.6 |
| physical | Average particle diameter (mm) | 0.38 | 0.22 | 0.28 | 0.32 | 0.16 | 0.38 | 0.08 | 0.25 | 0.14 |
| properties of | Loose bulk density (kg/m³) | 714 | 759 | 743 | 756 | 679 | 749 | 446 | 507 | 202 |
| powder | Solid bulk density (kg/m³) | 779 | 833 | 796 | 817 | 794 | 818 | 688 | 766 | 248 |
| granules | Degree of compaction | 8 | 9 | 7 | 7 | 14 | 8 | 35 | 34 | 18 |
| | (%) | | | | | | | | | |
| | Caking resistance (%) | 100 | 99 | 100 | 90 | 95 | 99 | 17 | 49 | 71 |
| | Rate of dissolution (sec) | 32 | 35 | 21 | 30 | 44 | 28 | 118 | 45 | 66 |

1. Anionic surfactant powder granules having an average particle diameter of 0.1 mm or more to less than 0.5 mm, a loose bulk density of 400 to 1000 kg/m³ and a compaction degree of 3 to 25%, comprising an anionic surfactant in an amount of 80 to 100 wt % based on the total amount of the powder granules.

2. The anionic surfactant powder granules according to claim 1, which are obtained by feeding an aqueous solution of an anionic surfactant into a granulator having an agitating element and a crushing element under reduced pressure, while drying and simultaneously granulating it.

3. The anionic surfactant powder granules according to claim 2, wherein the temperature of the powder granules during the drying and simultaneous granulation is 35 to 85° C., and the change in temperature of the powder granules is within ±5° C.

4. The anionic surfactant powder granules according to claim 2 or 3, wherein the pressure in the granulator is 0.67 to 40 kPa.

5. A process for producing the anionic surfactant powder granules of claim 1, which comprises the step of feeding an aqueous solution of an anionic surfactant into a granulator having an agitating element and a crushing element under reduced pressure, while drying and simultaneously granulating it.
